(19) United States
(12) Patent Application Publication
(10) Pub. No.: US 2002/0059117 A1
(43) Pub. Date: May 16, 2002

(54) Methods of generating revenue using streaming video with associated links

(75) Inventors: Ted Yoch, Edina, MN (US); Steve Madsen, St. Louis Park, MN (US); Nancy Anderson-Smith, Maple Plain, MN (US)

Correspondence Address: Brian N. Tufte, CROMPTON, SEAGER & TUFTE, LLC, Suite 895, 331 Second Avenue South, Minneapolis, MN, 55401-2246, US

(73) Assignee: ARAnet, Inc

(21) Appl. No.: 09/978,328

(22) Filed: Oct. 15, 2001

Related U.S. Application Data
(60) Provisional application No. 60/246,957, filed on Nov. 10, 2000.

(51) Int. Cl. G06F 17/60

(52) U.S. Cl. 705/27

(57) ABSTRACT

Methods and systems for generating revenue using a streaming video that includes primarily informative content for users are disclosed. An indication of one or more products or services is preferably provided in the informative content of the streaming video. The indication may be a picture of the product or service, or an audio indication, or both as desired. A link is preferably placed in the streaming video that directly or indirectly links a user or viewer to a site that has additional information related to the one or more products or services indicated in the streaming video. Revenue may be generated from companies that offer the products or services that are indicated or featured in the streaming video. The service or business that provides the streaming video, the companies that offer the products or services, and/or the web site(s) that distribute the streaming video may receive some or all of the generated revenue, preferably in a revenue sharing arrangement.

This application claims priority under 35 U.S.C. §119(e)(1) to U.S. Provisional Patent Application Ser. No. 60/246,957, filed Nov. 10, 2000, and entitled “Methods of Generating Revenue Using Streaming Video With Associated Hyperlinks”.

### TECHNICAL FIELD OF THE INVENTION

The present invention relates to methods and systems for generating revenue using streaming video over the Internet, and more particularly, to methods and systems for generating revenue using streaming video with associated links or hot spots.

### BACKGROUND OF THE INVENTION

The Internet includes a vast number of computers and computer networks that are interconnected through communication links. The interconnected computers exchange information using various services, such as electronic mail, and the World Wide Web (“WWW”). The WWW service allows a server computer system (i.e., Web server or Web site) to send graphical Web pages of information to a remote client computer system. The remote client computer system can then display the Web pages.

Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends the Web page to the client computer system. When the client computer system receives the Web page, it typically displays the Web page using a browser. A browser is a special-purpose application program that supports the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a particular Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to electronic commerce. Many web sites have been developed through which vendors can display advertisements for their products or services. Advertising on web sites can take on many forms. One common form is the display of banner ads. Banner ads are typically relatively small ads that are periodically displayed on a web site. A banner ad often includes a hyperlink to the home page of the advertiser. Many web sites charge per 1000 banner impressions (CPM).

While banner ads can be effective in some situations, there is a growing concern that banner ads do not produce acceptable results. This is evidenced by the recent decline in the average CPM rates that can be charged for banner ads. One criticism of banner ads is that they are not very rich, and therefore do not attract the attention of the users. Banner ads are still, however, the solution of choice because of the relatively small size and relatively fast download times that can be achieved.

Additional cabling, hardware and software capabilities are rapidly being developed and added to increase the bandwidth of the Internet. This additional bandwidth will allow much more rich content to be delivered, without substantially increasing the download times of most sites. Streaming video is one medium that will be leveraged as the bandwidth of the Internet increases.

### SUMMARY OF THE INVENTION

The present invention provides methods and systems for generating revenue using a streaming video that includes primarily informative content for users. An indication of one or more products or services is preferably provided in the informative content of the streaming video. The indication may be a picture of the product or service, or an audio indication, or both as desired. A link is preferably placed in the streaming video that directly or indirectly links a user or viewer to a site that has additional information related to the one or more products or services indicated in the streaming video. This link is placed in the streaming video spatially, temporally, or both. Such a streaming video may be desirable to one or more web sites as content filler, and the one or more web sites may be used to distribute the streaming video to its users. Revenue may be generated from companies that offer the products or services that are indicated in the streaming video. The service or business that provides the streaming video, the companies that offer the products or services, and/or the web site(s) that distribute the streaming video may receive some or all of the generated revenue, preferably in a revenue sharing arrangement.

Rather than having the user select the link in the streaming video, it is contemplated that the link may be automatically activated when the product or service is indicated in the streaming video. When so provided, a separate pop-up window may be provided to display the additional information related to the one or more products or services indicated in the streaming video. Alternatively, an area or region within the current window may be changed to display the additional information related to the one or more products or services indicated in the streaming video.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the Figures thereof and wherein:

FIG. 1 is a screen shot of a first illustrative embodiment of the present invention;

FIG. 2 is a screen shot of another illustrative embodiment of the present invention; and

FIG. 3 is a screen shot of yet another illustrative embodiment of the present invention.

### DETAILED DESCRIPTION

The present invention provides methods and systems for generating revenue using streaming videos that have one or more associated hyperlink. Streaming videos typically have a spatial component (i.e., location) and a temporal component (i.e., time). The streaming videos used in accordance with the present invention preferably have one or more links that are associated with the streaming video, either spatially, temporally, or both. To generate revenue, the present invention contemplates entering into revenue sharing arrangements with companies that offer products or services that are indicated in the streaming videos. Revenue sharing arrangements may also be made with web sites that offer and distribute the streaming videos over the Internet or the like, if desired.

In one embodiment, links or hot spots are placed at a convenient location (spatial or temporal) relative to the streaming video. For example, a hyperlinks may be placed adjacent to the streaming video (e.g., above, below, along side). Alternatively, or in addition, a hyperlink may be laid over the streaming video, either at a predetermined static location or next to a product or service that is displayed or featured in the streaming video. The links may also be placed temporally within the streaming video. That is, one or more links may be displayed during a particular time within the streaming video. This may allow multiple temporally spaced hyperlinks to be displayed during a single streaming video, each during a predetermined relevant time. The relevant time may be, for example, when a corresponding product or service is discussed or shown in the streaming video.

The streaming videos used in conjunction with the present invention are preferably produced as feature online presentations, providing valuable content in much the same way as feature articles do for newspapers and magazines. In one embodiment, the intent is to produce streaming videos that can be used by site editors as content filler for their web sites. As such, the streaming videos are preferably primarily informative in nature, which are low on commercialism and high on content and information. For example, the streaming videos may provide useful information such as home decorating tips, financial planning tips, or any other type of information that users may find interesting and informative. This is in contrast to a commercial streaming video, which places high emphasis on a particular company, product or service. Preferably, the streaming videos used in conjunction with the present invention have greater than 50% informative or useful content, and less than 50% commercial content (e.g. content that is focused on a particular company, product or service). More preferably, the streaming videos have greater than 80% informative or useful content and less than 20% commercial content. Even more preferably, the streaming videos of the present invention have greater than 90% informative or useful content and less than 10% commercial content.

To generate revenue, a service may be provided that produces online feature presentation videos, converts the videos into streaming videos, inserts appropriate links (such as hyperlinks or hot spots) into the streaming videos, and/or promotes the streaming videos on the Internet. The service preferably enters into an agreement with one or more clients that want to sell one or more products or services via the Internet. One such client may be, for example, Environmental Graphics, which sells among other things wall murals. The client may produce a video, or the service may produce the video for the client.

Once the video is produced, the service may format the video into one or more streaming video formats. During the formatting process, the service preferably inserts one or more revenue sharing links into the streaming video. It is contemplated that a hyperlink or hot spot may be displayed or activated when, for example, the streaming video shows or discusses the client's product or service. The hyperlink or hot spot may have a click through point, which takes the user to the client's web site or other designated site, where further information and/or an option to purchase is provided.

Rather than having the user click a hyperlink or the like in the streaming video, it is contemplated that the link may be automatically activated when the product or service is indicated in the streaming video. When so provided, a separate pop-up window or the like may be provided to display the one or more sites that have additional information related to the one or more products or services indicated in the streaming video. Alternatively, an area or region within the current window may be updated or changed to display the additional information related to the one or more products or services indicated in the streaming video.

To insert the links, a separate link track is preferably added to the streaming video. The link track is much like a video or audio track that currently exist on video and streaming video. The link track preferably allows the links or hot spots to be placed at desired spatial locations, and/or appears to be timed to the appropriate interactive streaming video content. One commercial software package that allows active links to be inserted into streaming video is called Cleaner-5, available from the Terran Corporation.

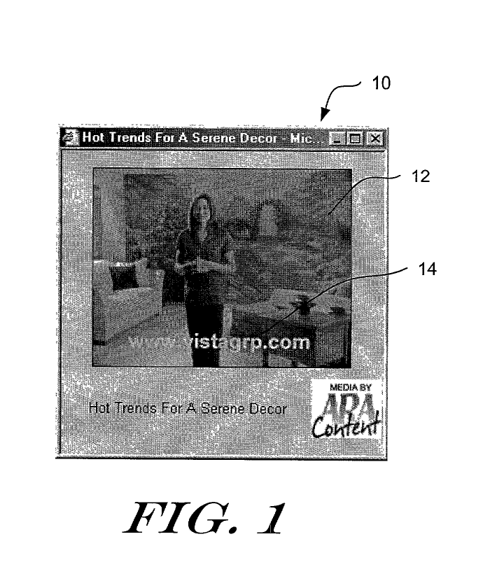

FIG. 1 is a screen shot of an example online feature streaming video 10, with an overlaid or embedded hyperlink 12. The illustrative streaming video provides valuable content related to home decorating tips, in much the same way as a feature article would for newspapers and magazines. A picture of the product or service, or an audio indication, or both may be provided. In the illustrative streaming video, a wall mural 12 is shown in the background.

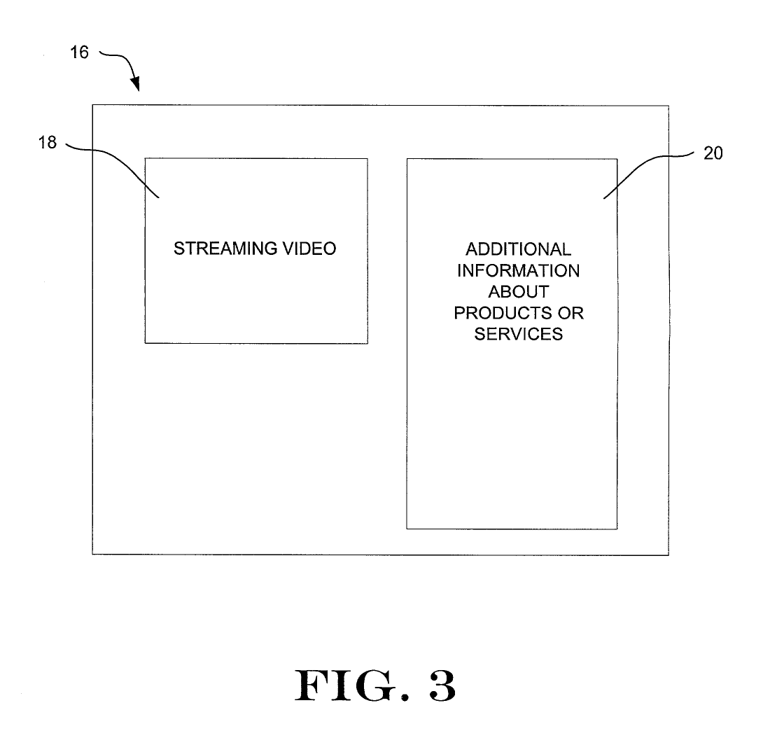

The hyperlink 14, when selected, may refer the user to an existing company's web site, such as http://www.vistagrp.com. This hyperlink 14 may be displayed when, for example, a product or service available from the Vista Group is mentioned (audio) or displayed (visual) in the online feature streaming video. The hyperlink 14, or hot spot, when clicked, may take the user (e.g., potential consumer) to the client's web site for possible purchase of the product or service. Alternatively, and instead of having the user manually select the link in the streaming video, the link may be automatically activated when the corresponding product or service is indicated in the streaming video. When so provided, a separate pop-up window may be provided to display the additional information related to the one or more products or services, although such a separate popup window is not required. Alternatively, a designated area or region within the current window may be updated to display the additional information related to the one or more products or services, as further shown and described below with reference to FIG. 3.

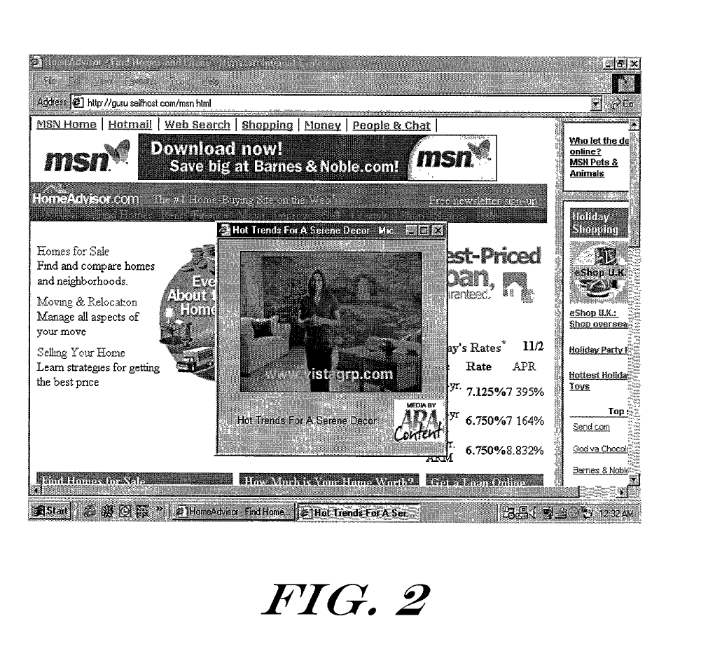

The service also preferably seeks out participating web sites to promote the linked streaming videos over the Internet. Editors of many web sites are often looking for good content or content filler for their sites. Streaming videos that include feature online presentations may provide such content filler, much like feature articles provide filler content for newspapers and magazines. Preferably, a revenue sharing agreement is made with one or more participating web sites, which provide the participating web sites with a share of the revenue generated from advertising or sales generated by the links in the streaming videos. Such a revenue sharing agreement provides an incentive for the participating web sites to promote the streaming video to its users. The revenue share may be based on, for example, the number of times the additional information related to the one or more products or services is displayed (e.g., advertising), the amount of first purchases by each user that follows one of the links in the streaming videos (e.g., sales), or any other revenue share arragement. FIG. 2 shows an illustrative pop-up window that may be displayed when a streaming video is selected by a user of a participating web site, such as MSN.com.

In one illustrative example, a client (e.g., Environmental Graphics) may agree to pay a 6% revenue share to the service. The service may then agree to pay the participating web sites a 3% revenue share for making the streaming video available for distribution. The service thus retains a 3% revenue share for the service it provides. Such a revenue sharing model rewards the participating web sites with valuable content as well revenue for promoting the streaming video, and rewards the service for producing and/or distributing the streaming videos. The client is rewarded with increased sales.

The service preferably retains the right to audit logs, reports and purchasing records in order to ensure appropriate revenue sharing is maintained. The service preferably relies on the client server purchase log to show what accesses resulted in purchases. This log preferably records the purchaser, which web site they came from, and if they made a purchase. All of this can be analyzed by the client company to determine revenue from the interactive streaming video and the corresponding amount of revenue sharing to be paid to the service. The client preferably provides the service with a monthly summary of revenue.

In the case an audit is necessary, the service may compare their streaming video server log with the client server purchase log for the particular product in the interactive streaming video. By comparing these two logs, it is possible for the service to verify the accuracy of the accesses reported by the client company. The service, by agreement, preferably retains the right to audit the sales of the client company.

FIG. 3 shows a screen shot of another illustrative embodiment of the present invention. In this embodiment, a window 16 includes a first region 18 for displaying the streaming video and a second region 20 for displaying additional information related to the one or more products or services indicated in the streaming video. When a hyperlink is provided in the streaming video, a user may manually select the hyperlink to update the second region 20 with additional information related to the corresponding product or service. Alternative, when the link is automatically activated, the second region 20 may automatically display additional information related to the corresponding product or service.

Having thus described the preferred embodiments of the present invention, those of skill in the art will readily appreciate that the teachings found herein may be applied to yet other embodiments within the scope of the claims hereto attached.

What is claimed is:

1. A method for generating a streaming video, comprising:
providing a streaming video that includes primarily informative content for users;
providing an indication of one or more products or services within the informative content of the streaming video; and
providing a link in the streaming video that directly or indirectly displays to the users additional information related to the one or more products or services.

2. A method according to claim 1, further comprising the step of marketing the streaming video to one or more web site editors for filler content.

3. A method for generating revenue using streaming video, comprising:
providing a streaming video that includes primarily informative content for users;
providing an indication of one or more products or services within the informative content of the streaming video;
providing a link in the streaming video that directly or indirectly displays additional information related to the one or more products or services;
allowing users to access the streaming video; and
generating revenue by displaying the additional information and/or having one or more of the users purchase one or more of the products or services.

4. A method according to claim 3, further comprising the step of providing the streaming video to one or more web sites that provide users access to the streaming video.

5. A method according to claim 4, wherein the streaming video is provided to the one or more web sites for free.

6. A method according to claim 4, further comprising the step of sharing the generated revenue with the one or more web sites.

7. A method according to claim 3, wherein revenue is generated each time the link in the streaming video is activated.

8. A method according to claim 7, wherein the link is activated manually by a user.

9. A method according to claim 7, wherein the link is activated automatically through the streaming video.

10. A method for generating revenue using streaming video, comprising:
providing a streaming video that includes primarily informative content for users;
providing an indication of one or more products or services within the informative content of the streaming video;
providing a link in the streaming video that automatically triggers the display of additional information related to the one or more products or services;
providing the streaming video to one or more web sites for distribution; and
generating revenue as a result of one or more users viewing the additional information related to the one or more products or services.

11. A method according to claim 10, wherein revenue is generated each time additional information related to the one or more products or services is displayed.

12. A method according to claim 10, wherein revenue is generated each time a user actually purchases one or more of the products or services indicated in the streaming video.

13. A method according to claim 10, wherein the streaming video is provided to the one or more web sites for free.

14. A method according to claim 10, wherein the streaming video is used as content filler for the one or more web sites.

15. A method according to claim 10, further comprising the step of sharing the generated revenue with the one or more web sites.

16. A method according to claim 10, wherein the streaming video is displayed in a first region of a window and the additional information related to the one or more products or services is displayed in a second region of the window.

17. A method according to claim 10, wherein the streaming video is displayed in a first window and the additional information related to the one or more products or services is displayed in a second window.
